(19) United States
(12) Patent Application Publication
(10) Pub. No.: US 2024/0257279 A1
(43) Pub. Date: Aug. 1, 2024

(54) MACHINE-BASED COMMUNICATION TOOL FOR TRANSACTION MONITORING AND EXECUTION

(71) Applicant: Circle The People Inc., Carlsbad, CA (US)

(72) Inventor: Danny M. Brooking, Carlsbad, CA (US)

(73) Assignee: Circle The People Inc., Carlsbad, CA (US)

(21) Appl. No.: 18/425,789

(22) Filed: Jan. 29, 2024

Related U.S. Application Data
(60) Provisional application No. 63/442,695, filed on Feb. 1, 2023.

(51) Int. Cl. G06Q 50/163; G06Q 50/00

(52) U.S. Cl. CPC G06Q 50/163; G06Q 50/01

(57) ABSTRACT

Aspects of the disclosure are directed to machine-based communications. In accordance with one aspect, the disclosure includes enabling a communication chat line among a plurality of subscribers and informing one or more of the plurality of subscribers of an information of available properties; establishing a transaction timeline by incorporating a plurality of actions and an associated plurality of date/time alerts for a selected property from the available properties; and disseminating one or more communications relating to the plurality of actions and the associated plurality of date/time alerts for the selected property using the communication chat line to the one or more of the plurality of subscribers.

### CLAIM OF PRIORITY UNDER 35 U.S.C. § 119

The present Application for Patent claims priority to Provisional Application No. 63/442,695 entitled “Machine-Based Communication Tool For Transaction Monitoring And Execution” filed Feb. 1, 2023, and assigned to the assignee hereof and hereby expressly incorporated by reference herein.

### TECHNICAL FIELD

This disclosure relates generally to the field of interactive communication, and, in particular, to machine-based communication.

### BACKGROUND

A transaction, a series of exchanges that results in a transfer of assets between two parties, for example, a buyer and a seller, requires significant coordination and communication among many participants. One type of transaction, a real estate transaction, involves a series of exchanges among participants which culminates in a transfer of a real estate asset from the seller to the buyer and an exchange of money from the buyer to the seller. The real estate transaction requires several tasks and products among the participants which need synchronization (i.e., coordination) and information exchange. Thus, a machine-based communication tool for managing the monitoring and execution of the transaction among multiple participants is desired.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides machine-based communication. Accordingly, a method including: enabling a communication chat line among a plurality of subscribers and informing one or more of the plurality of subscribers of an information of available properties; establishing a transaction timeline by incorporating a plurality of actions and an associated plurality of date/time alerts for a selected property from the available properties; and disseminating one or more communications relating to the plurality of actions and the associated plurality of date/time alerts for the selected property using the communication chat line to the one or more of the plurality of subscribers.

In one example, the method further includes tracking one or more of the plurality of actions based on the associated plurality of date/time alerts. In one example, the method further includes sending one or more of the associated plurality of date/time alerts to the plurality of subscribers using the communication chat line. In one example, the method further includes informing the one or more of the plurality of subscribers of a status of the one or more of the plurality of actions using the communication chat line. In one example, the method further includes providing one or more documentation of the plurality of actions to the one or more of the plurality of subscribers using the communication chat line. In one example, the method further includes receiving a plurality of property criteria and using the plurality of property criteria to survey a database of available properties. In one example, the method further includes outputting a list of the available properties based on the plurality of property criteria. In one example, the method further includes gathering a numeric rating of one of the plurality of subscribers from another of the plurality of subscribers. In one example, the method further includes, upon completion of the gathering, posting the numeric rating on a social media platform.

In one example, the communication chat line accommodates a multiaccess communication among the plurality of subscribers. In one example, wherein the multiaccess communication includes a private group messaging using encryption.

Another aspect of the disclosure provides an apparatus including: a memory configured to store a database of available properties; a central processing unit (CPU) coupled to the memory, the CPU configured to enable a communication chat line among a plurality of subscribers, and configured to establish a transaction timeline; and a modem coupled to the CPU, the modem configured to disseminate one or more communications relating to a plurality of actions and an associated plurality of date/time alerts for a selected property; wherein the selected property is one of the available properties.

In one example, the apparatus further includes a display coupled to the CPU, the display configured to inform at least one of the plurality of subscribers of a status of one of the plurality of actions. In one example, the apparatus further includes a databus configured to allow coupling between any of the following: the memory, the CPU, the modem and the display.

In one example, the CPU is further configured to incorporate the plurality of actions and the associated plurality of date/time alerts into the transaction timeline. In one example, the display is further configured to provide a documentation of the one of the plurality of actions to the at least one of the plurality of subscribers. In one example, the modem is further configured to receive a plurality of property criteria. In one example, the CPU is further configured to output a list of the available properties based on the plurality of property criteria. In one example, the modem is further configured to allow multiaccess communication among the plurality of subscribers. In one example, the CPU is further configured to gather a numeric rating of one of the plurality of subscribers from another of the plurality of subscribers, and further configured to post the numeric rating on a social media platform.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example transactional network with a plurality of nodes.

FIG. 2 illustrates an example of a plurality of itemized tasks for a real estate transaction.

FIG. 3 illustrates an example login screen on a machine-based communication tool.

FIG. 4 illustrates an example welcome back screen on the machine-based communication tool.

FIG. 5 illustrates an example dashboard screen on the machine-based communication tool.

FIG. 6 illustrates an example active circles screen on the machine-based communication tool.

FIG. 7 illustrates an example task list screen on the machine-based communication tool.

FIG. 8 illustrates an example chat screen on the machine-based communication tool.

FIG. 9 illustrates an example account settings screen on the machine-based communication tool.

FIG. 10 illustrates an example ratings screen on the machine-based communication tool.

FIG. 11 illustrates an example ratings social media screen on the machine-based communication tool.

FIG. 12 illustrates an example escrow calendar screen on the machine-based communication tool.

FIG. 13 illustrates an example search screen on the machine-based communication tool.

FIG. 14 illustrates an example change screen on the machine-based communication tool.

FIG. 15 illustrates an example task button screen on the machine-based communication tool.

FIG. 16 illustrates an example get help/contact screen on the machine-based communication tool.

FIG. 17 illustrates an example mobile platform implementation of the machine-based communication.

FIG. 18 illustrates an example flow diagram for machine-based communication.

FIG. 19 illustrates an example implementation of a machine-based communication tool.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

A transaction, for example, a real estate transaction, may involve a plurality of participants who need to complete a plurality of tasks and to produce a plurality of products for successful execution. In one example, primary participants of the plurality of participants in the transaction are the seller and buyer, and other participants of the plurality of participants in the transaction may be a seller agent, buyer agent, lender, appraiser, escrow officer, broker, title officer, insurance agent, repairer, etc.

In one aspect, a transactional network is an aggregation of nodes and links which are interconnected to provide a service. In one example, the service is executed using a communication tool. For example, the communication tool may be a machine-based communication tool which is hosted on a digital platform (e.g., a mobile device, a laptop computer, a smartphone, etc.). In one example, a node corresponds to a participant and a link corresponds to a connection between nodes or participants. In one example, the aggregation of nodes is interconnected with a plurality of links. The service may be a real estate transaction, a sales transaction, a legal service, a manufacturing process, an event plan, a construction project, etc.

An important feature of the transactional network is the ability for any or all nodes to connect and communicate with each other. That is, the interconnectivity of the transactional network establishes its value. In one example, the value of the transactional network may be proportional to the square of the number of nodes (e.g., Metcalfe's Law). That is, if each node represents a participant in the service and if there are N participants, the value of the transactional network may be proportional to N². For example, doubling the number of nodes may increase the transactional network value by a factor of four. Thus, the value proposition for a transactional network which is fully interconnected among all its nodes is potentially very high.

The transactional network may include a plurality of nodes or participants, a plurality of links or connections, a plurality of tasks, a plurality of products, etc. In one example, each node of the plurality of nodes corresponds to a participant and includes a communications device (e.g., a mobile device). For example, each participant in the transaction uses the communications device which is connected to other participants via the transactional network to send information and messages.

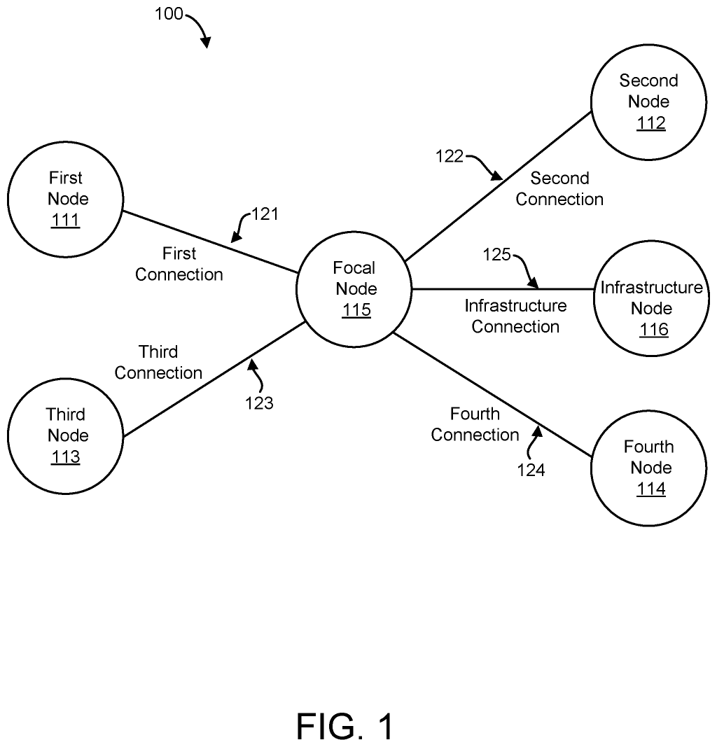

FIG. 1 illustrates an example transactional network 100 with a plurality of nodes 110 which includes a first node 111, a second node 112, a third node 113, a fourth node 114, a focal node 115 and an infrastructure node 116 and a plurality of links 121, 122, 123, 124, 125. In one example, the links are labeled as connections. The nodes may be participants in a transaction, and the links provide connections among the nodes. The quantity of nodes in this example is not limiting and any quantity of nodes may be part of the transactional network 100.

For example, the first node 111, the second node 112, the third node 113 and the fourth node 114 may be interconnected to the focal node 115 in a hub topology. For example, the hub topology is characterized by at least one node, e.g., the focal node 115, having a number of links greater than an average number of links per node. For example, the focal node 115 may be connected to the infrastructure node 116 which provides certain background services for the transactional network 100 such as bulk storage, offline computation, specialized processing, etc. For example, each node of the plurality of nodes 110 corresponds to a participant in the transaction has a communications device which is connected to other participants via the transactional network.

In one example, the transactional network 100 includes a plurality of links 121, 122, 123, 124, 125 including a first link 121 (a.k.a. connection 121), a second link 122 (a.k.a. connection 122), a third link 123 (a.k.a. connection 123), a fourth link 124 (a.k.a. connection 124) and an infrastructure link 125 (a.k.a. connection 125). For example, the focal node 115 may be connected to the first node 111 via the first link 121 (a.k.a. connection 121), to the second node 112 via the second link 122 (a.k.a. connection 122), to the third node 113 via the third link 123 (a.k.a. connection 123), to the fourth node 114 via the fourth link 124 (a.k.a. connection 124), and to the infrastructure node 116 via the infrastructure link 125 (a.k.a. connection 125). For example, the plurality of links 121, 122, 123, 124, 125 may be wireless or wireline. For example, each connection of the plurality of links 121, 122, 123, 124, 125 may be bilateral (i.e., two way) and/or may be duplex (i.e., in both directions simultaneously).

In one example, the transactional network 100 includes a plurality of tasks and a plurality of products. In one example, the plurality of tasks are actions or state transitions which are executed by one or more of the plurality of nodes 110. In one example, the plurality of products are documents which are part of the transactional network.

In one example, the plurality of products is represented in digital form (e.g., in a machine-readable binary format). In one example, the plurality of products may be shared among the plurality of nodes 110 via message transport over the plurality of links 121, 122, 123, 124, 125.

In one example, the plurality of tasks and the plurality of products may be stored or displayed in one or more of the plurality of nodes 111, 112, 113, 114, 115, 116 of the transactional network 100. In one example, the plurality of tasks and the plurality of products may be stored and updated centrally in one node of the plurality of nodes 111, 112, 113, 114, 115, 116, for example, the focal node 115. In one example, the plurality of tasks and the plurality of products may be transported to other nodes of the plurality of nodes 111, 112, 113, 114, 115, 116 via the plurality of links 121, 122, 123, 124, 125.

In one example, the plurality of participants in the transaction includes the seller, buyer, seller agent, buyer agent, lender, appraiser, escrow officer, broker, title officer, insurance agent, repairer, etc. In one example, each participant of the plurality of participants includes one or more communications device which is connected to other participants of the plurality of participants via the transactional network. That is, each node of the plurality of nodes includes a participant and one or more communication device associated with the participant.

In one example, the seller owns an asset for sale, e.g., a real estate asset or property, and the buyer intends to purchase the asset by exchanging money with the seller. For example, the seller may be represented by the seller agent and the buyer may be represented by the buyer agent. In one example, the plurality of tasks and the plurality of products in the transaction may be governed by a transaction contract (e.g., sales contract).

In one example, the transaction contract may specify the plurality of tasks required to complete the transaction. In one example, the transaction contract may specify the plurality of products which are produced by the plurality of nodes (i.e., the participants).

In one example, the machine-based communication tool may be used to execute a service such as a real estate transaction, a sales transaction, a legal service, a manufacturing process, an event plan, a construction project, etc. For example, the machine-based communication tool is hosted on a digital platform (e.g., a mobile device, a laptop computer, a desktop computer, a smartphone, etc.). In one example, the machine-based communication tool is executed by a processor and memory in the digital platform. For example, the machine-based communication tool may include both hardware and software to execute the service.

In one example, the machine-based communication tool may be used for management and execution of the plurality of tasks and the plurality of products as part of the transactional network 100.

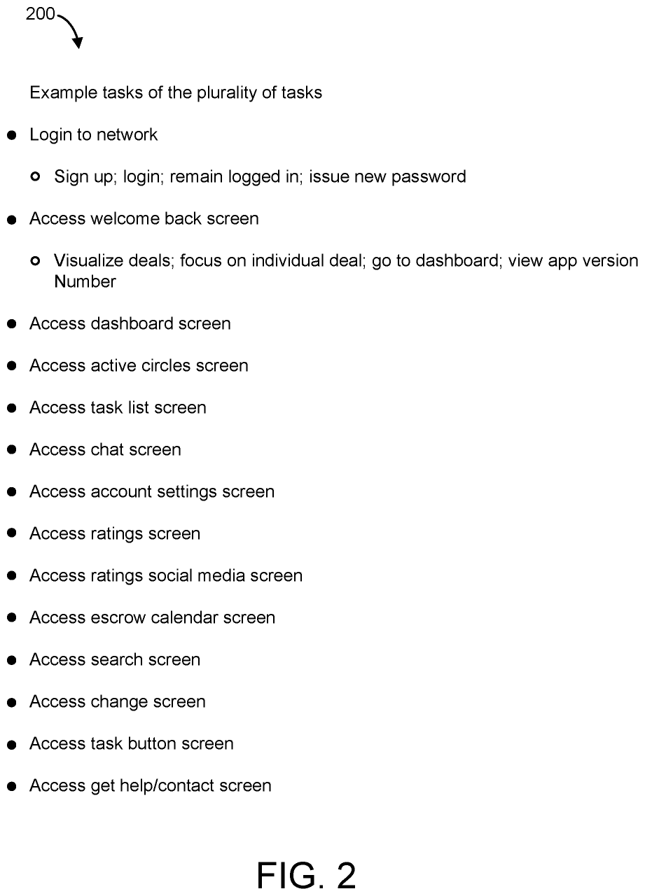

FIG. 2 illustrates an example of a plurality of itemized tasks for a real estate transaction. For example, the plurality of products may include sales contracts, escrow instruments, loan documents, credit reports, home inspection reports, pest control reports, repair documentation, financial information, etc.

In one example, the machine-based communication tool may be used to execute a service such as a real estate transaction as part of a transactional network. The transactional network is an aggregation of nodes and links, wherein the nodes correspond to participants and the links correspond to connections between nodes or participants. For example, the machine-based communication tool may be used to manage the monitoring and execution of the real estate transaction among multiple participants.

In one example, the machine-based communication tool may be configured to display a plurality of screens for the management and execution of the plurality of tasks and the plurality of products in the real estate transaction.

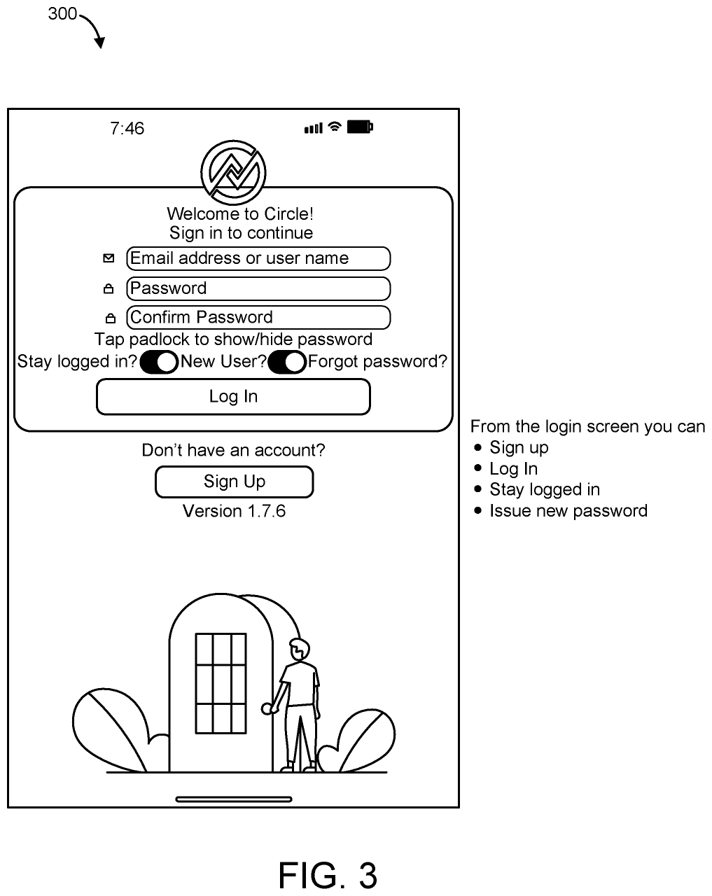

FIG. 3 illustrates an example login screen 300 on a machine-based communication tool. For example, the login screen 300 may be used to sign up, login, stay logged in, issue new password, etc.

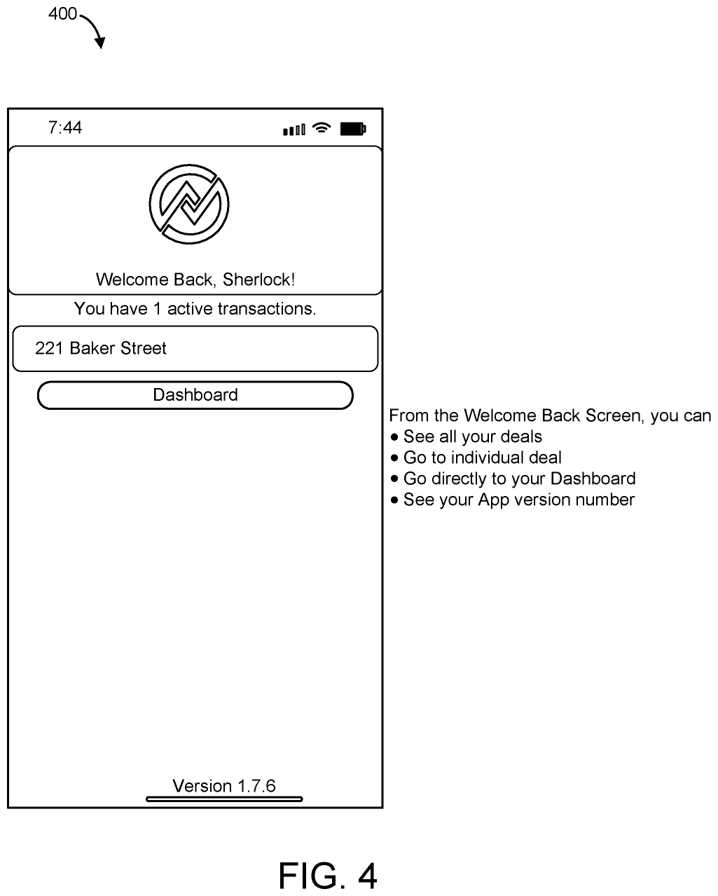

FIG. 4 illustrates an example welcome back screen 400 on the machine-based communication tool. For example, the welcome back screen 400 may be used to review all deals, go to an individual deal, go directly to a dashboard screen, review application version number, etc.

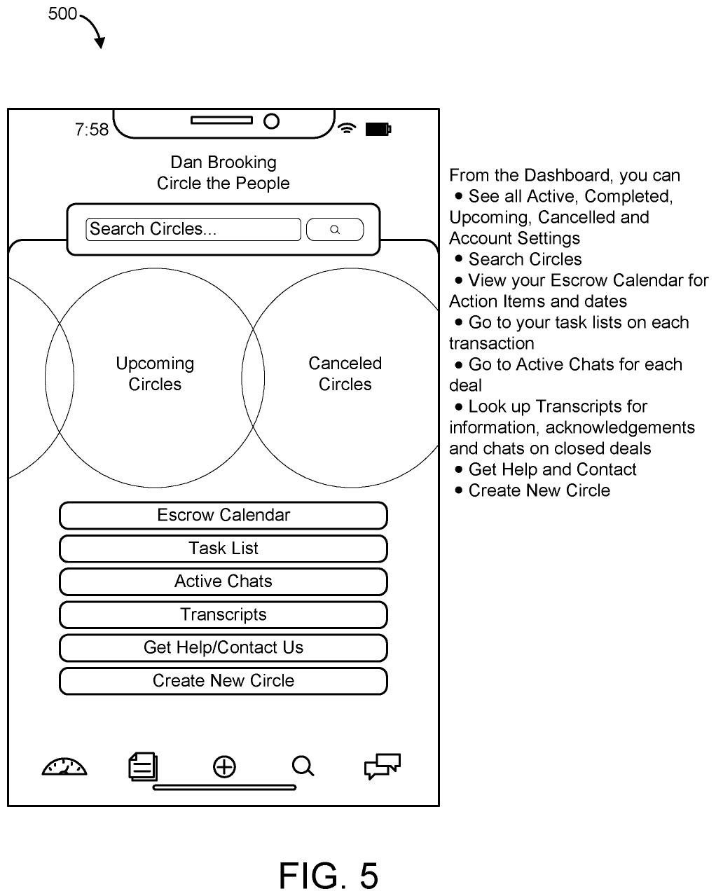

FIG. 5 illustrates an example dashboard screen 500 on the machine-based communication tool. For example, the dashboard screen 500 may be used to view all active, completed, upcoming, cancelled and account settings; view circles (e.g., transactions); view escrow calendar for action items and dates; go to task lists on each transaction; go to active chats for each deal; look up transcripts for information, acknowledgements and chats on closed deals; get help and contact; create new circle (e.g., new transaction); etc. In one example, a circle is a dashboard screen icon which represents a plurality of transactions (e.g., upcoming transactions, cancelled transactions, etc.).

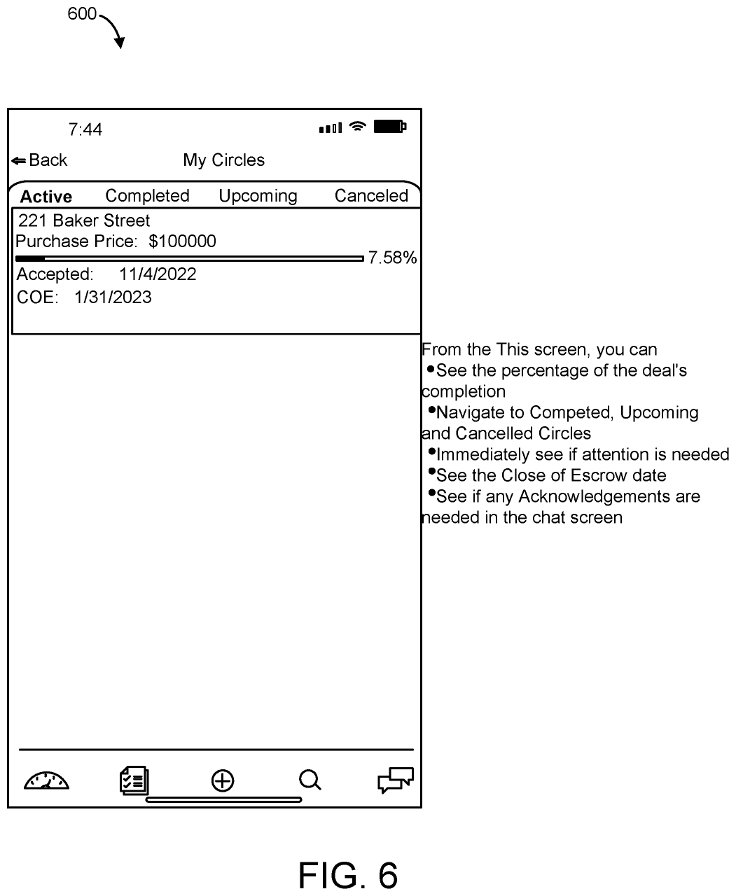

FIG. 6 illustrates an example active circles screen 600 on the machine-based communication tool. In one example, “active circles” are active transactions. For example, the active circles screen 600 may be used to view the percentage of a deal's completion; navigate to the completed, upcoming and cancelled circles (e.g., transactions); immediately see if attention is needed; view close of escrow date; view needs for acknowledgement in chat session; etc.

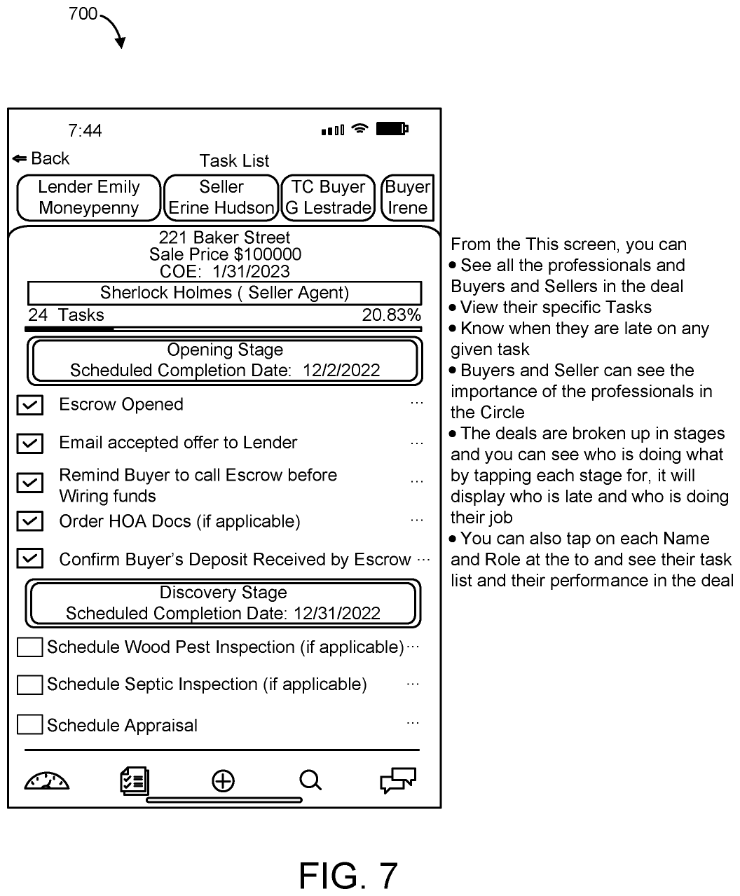

FIG. 7 illustrates an example task list screen 700 on the machine-based communication tool. For example, the task list screen 700 may be used to view all professionals, buyers and sellers in a deal; view specific tasks; know tardiness on any given task; view importance of professionals in the circle (e.g., transaction); view each deal by stages, tardiness status and task participants; view task list and performance for each name and role in the transaction; etc.

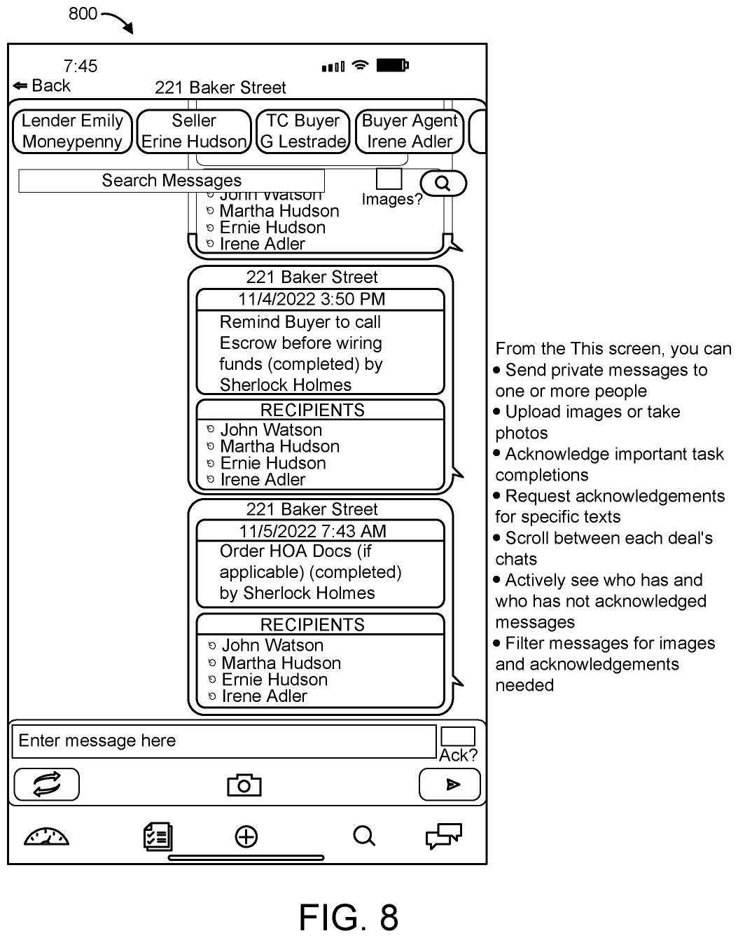

FIG. 8 illustrates an example chat screen 800 on the machine-based communication tool. For example, the chat screen 800 may be used to send private messages to one or more participant; upload images and take photos; acknowledge important task completions; request acknowledgement for specific tasks; scroll among chats for each deal; actively view participant's acknowledgement status; filter messages for images and acknowledgements needed; etc.

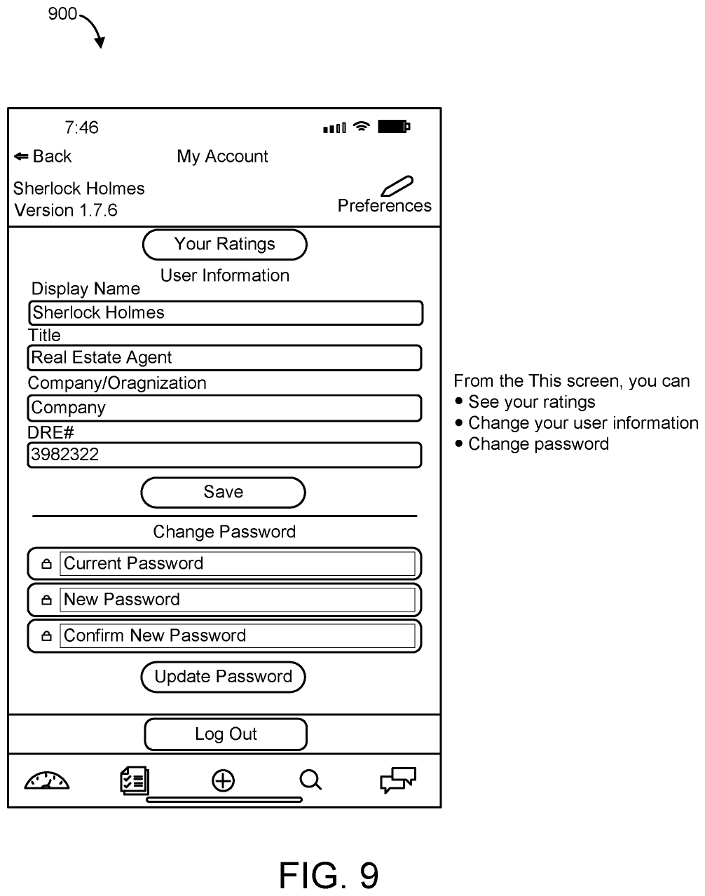

FIG. 9 illustrates an example account settings screen 900 on the machine-based communication tool. For example, the account settings screen 900 may be used to view ratings, change user information, change password, etc.

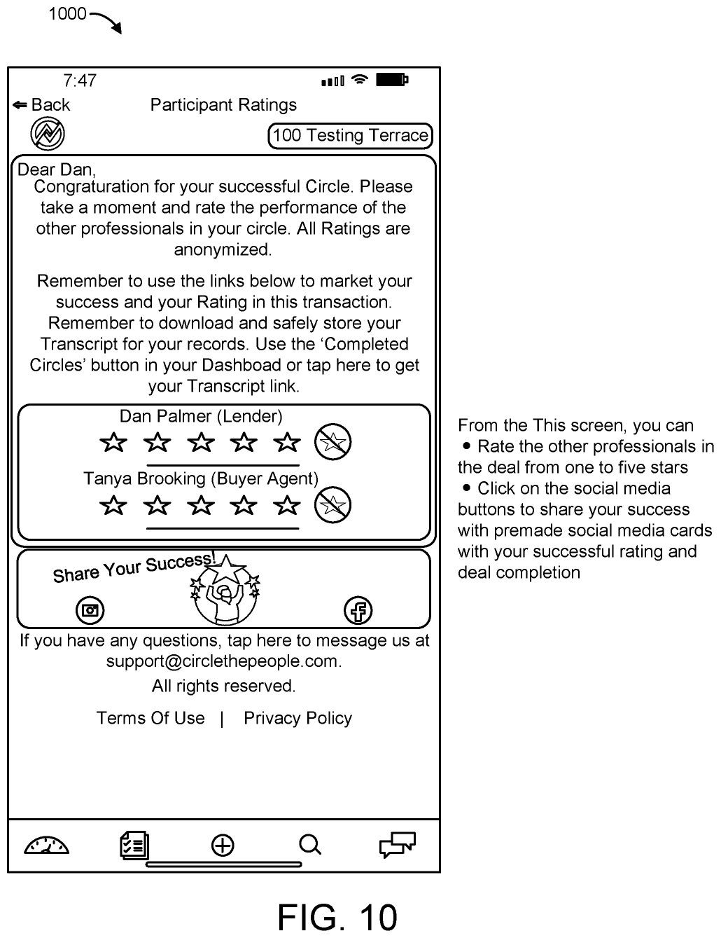

FIG. 10 illustrates an example ratings screen 1000 on the machine-based communication tool. For example, the ratings screen 1000 may be used to rate other professionals in the deal, access social media buttons with premade social media cards which document deal completion and ratings, etc.

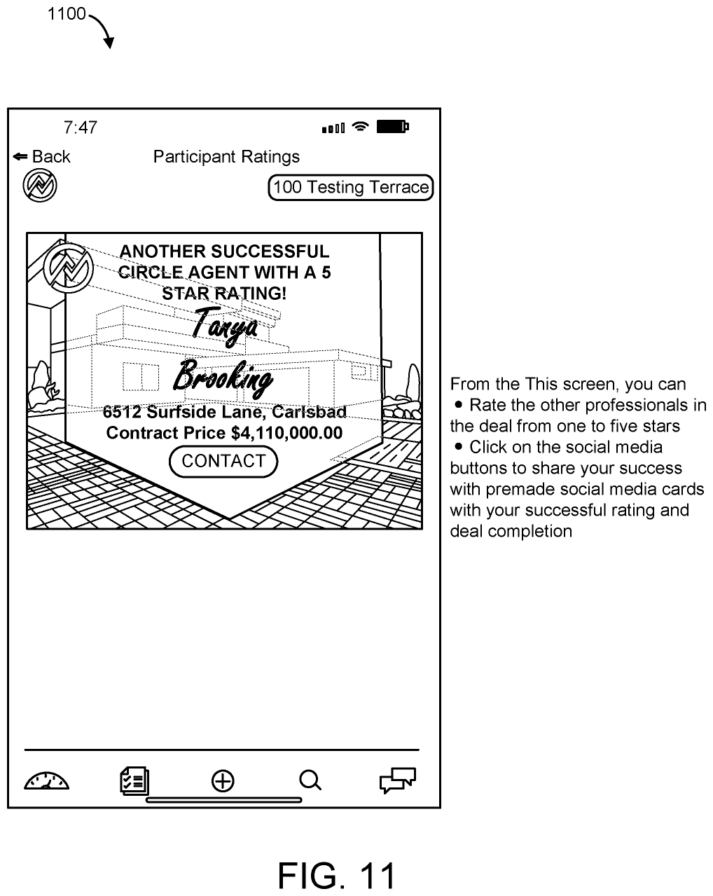

FIG. 11 illustrates an example ratings social media screen 1100 on the machine-based communication tool. For example, the ratings social media screen 1100 may be used to rate other professionals, access social media buttons with premade social media cards which document deal completion and ratings, etc.

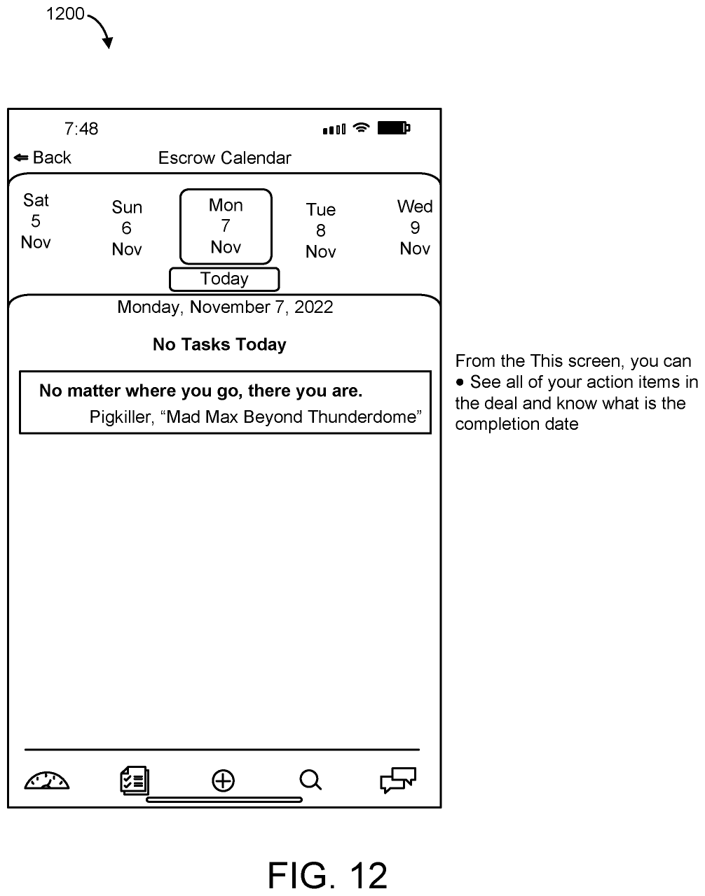

FIG. 12 illustrates an example escrow calendar screen 1200 on the machine-based communication tool. For example, the escrow calendar screen 1200 may be used to view action items and completion dates in the deal, etc.

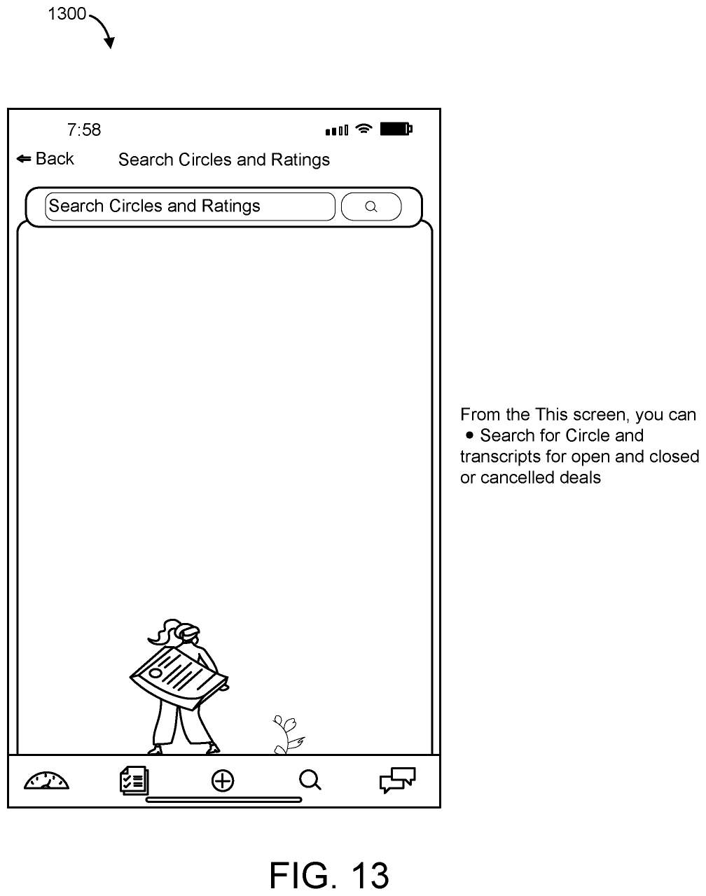

FIG. 13 illustrates an example search screen 1300 on the machine-based communication tool. For example, the search screen 1300 may be used to search the circle (e.g., transaction); and transcripts for open, closed or cancelled deals, etc.

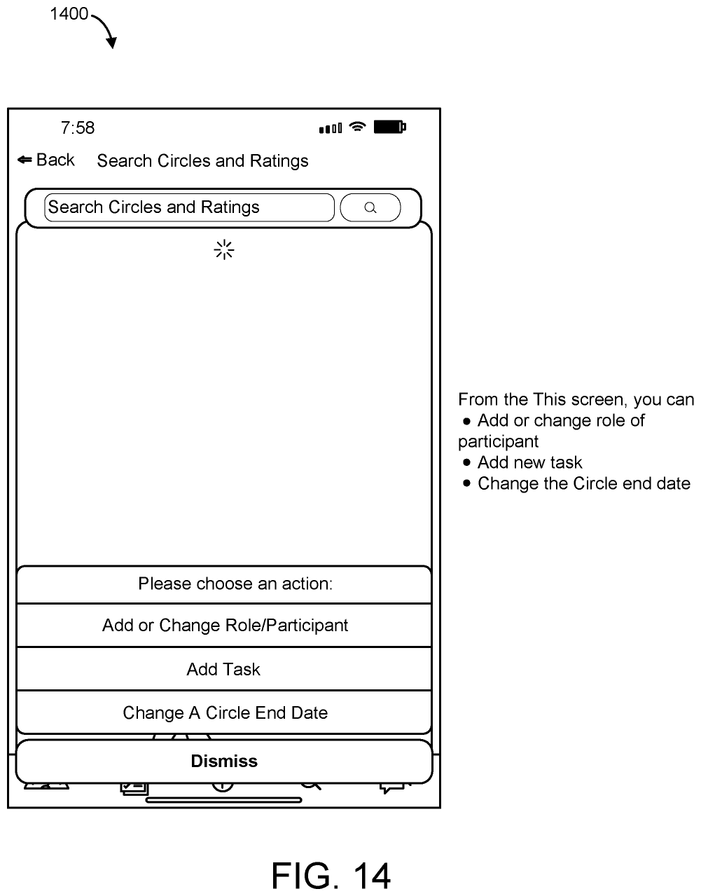

FIG. 14 illustrates an example change screen 1400 on the machine-based communication tool. For example, the change screen 1400 may be used to add or change the role of a participant, add a new task, change a circle (e.g., transaction) end date, etc.

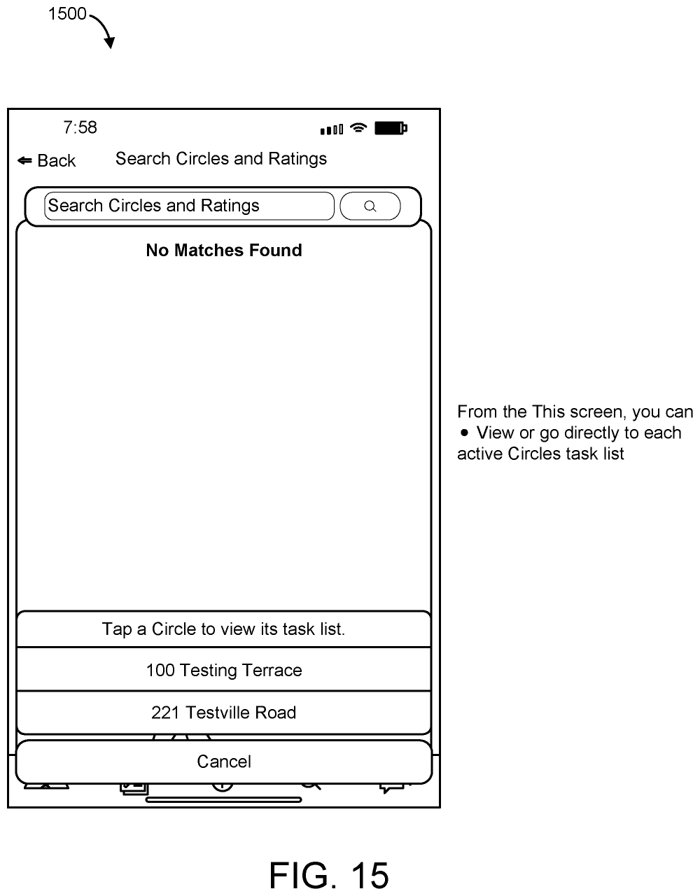

FIG. 15 illustrates an example task button screen 1500 on the machine-based communication tool. For example, the task button screen 1500 may be used to view or to directly to each active circle task list, etc.

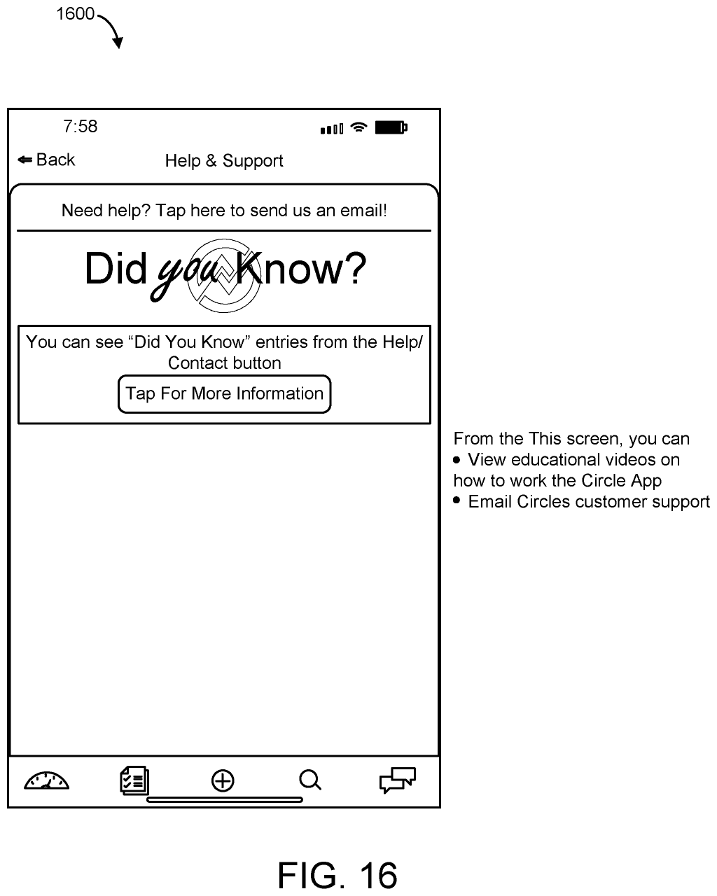

FIG. 16 illustrates an example get help/contact screen 1600 on the machine-based communication tool. For example, the get help/contact screen 1600 may be used to access educational videos on using the machine-based communication tool, contact customer support via email, etc.

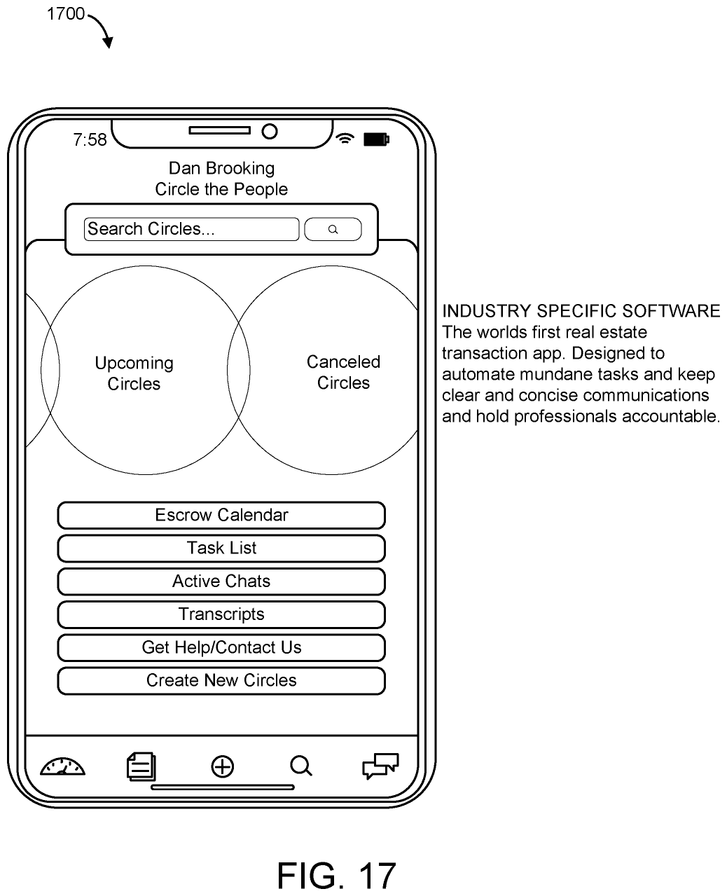

FIG. 17 illustrates an example mobile platform implementation 1700 of the machine-based communication for transaction monitoring and execution. In one example, the machine-based communication tool in accordance to the present disclosure may include advanced natural language processing (NLP) for improved chat interactions, image recognition for analyzing and presenting property visuals, and/or predictive analytics for market insights and personalized property recommendations, etc. In one example, virtual reality/augmented reality (VR/AR) technology may offer virtual property tours, and Internet of Things (IoT) integration may provide real-time data for smart homes. Artificial Intelligence (AI)-driven task management may streamline escrow tasks, and machine learning for fraud detection to ensure secure operations. For example, chatbots may offer efficient customer support. Additionally, for example, the machine-based communication tool in accordance to the present disclosure may include real-time house price lookups, data on comparable sales for market analysis, and/or AI-assisted tools to connect users with agents, and thus, may allow enhancing decision-making and user experience in the real estate journey.

That is, in one aspect, the machine-based communication tool includes advanced natural language processing (NLP) for improved chat interactions, image recognition for analyzing and presenting property visuals and predictive analytics for market insights and personalized property recommendations. For example, NLP is based on machine understanding and interpretation of human language in either written or spoken form. In one example, virtual reality/augmented reality (VR/AR) technology may offer virtual property tours, and Internet of Things (IoT) integration provides real-time data for smart homes. For example, VR/AR provides a machine-based immersive simulation environment which emulates a real (i.e., physical) environment. In one example, artificial intelligence (AI)-driven task management may streamline escrow tasks, and machine learning (ML) for fraud detection ensures secure operations. For example, AI and ML involve machine manipulation of existing data to form algorithms which may optimally process future data, according to some mathematical optimization rule. In one example, chatbots may offer efficient customer support. In addition, real-time house price lookups, comparable sales data for market analysis and AI-assisted tools to connect users with agents may enhance decision-making and user experience in a real estate transaction.

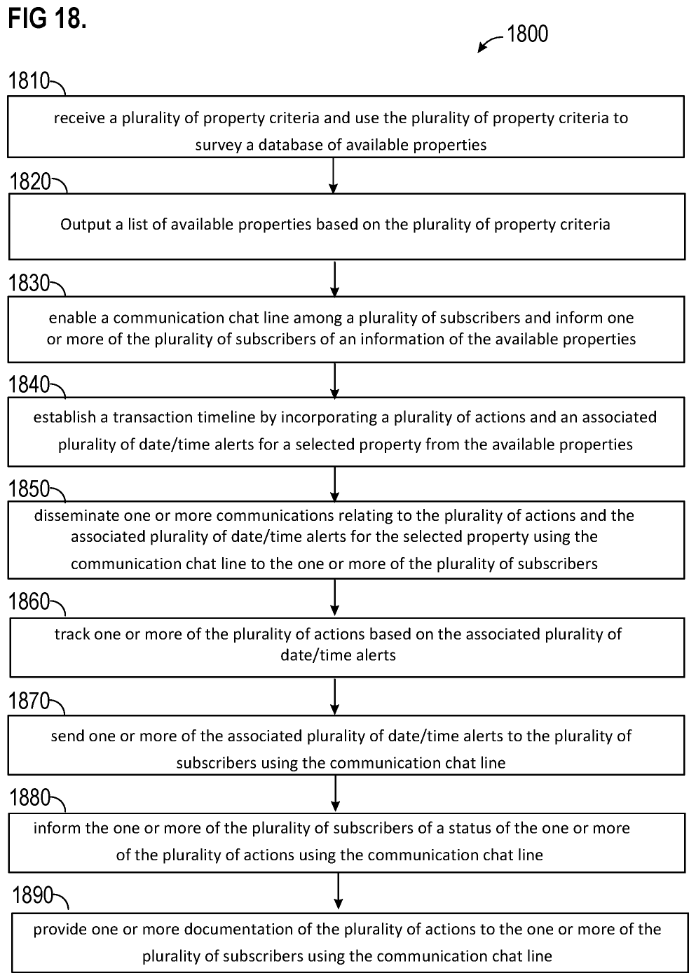

FIG. 18 illustrates an example flow diagram for machine-based communication. In block 1810, receive a plurality of property criteria and use the plurality of property criteria to survey a database of available properties. In one example, plurality of property criteria may include one or more of the following: location of property, quantity of bedrooms, quantity of bathrooms, single story building or multi-story building, price range, age of the building, garage information, minimum or maximum lot size, yard size information, etc.

In one example, the database is a Multiple Listing Service (MLS). In one example, available property refers to houses, condominiums, townhouses (and even vacant lots) that are available for purchase. In one example, the survey includes image recognition for analyzing and presenting property visuals and predictive analytics for market insights and personalized property recommendations. In one example, the survey includes real-time house price lookups, comparable sales data for market analysis and AI-assisted tools to connect users with agents.

In block 1820, output a list of available properties based on the plurality of property criteria. For example, the machine-based communication tool analyzes the content of the database of available properties, determines which of the available properties meet the plurality of property criteria and then generates a subset list of the available properties for outputting. This subset list is a list of properties that meet the plurality of property criteria.

In block 1830, enable a communication chat line among a plurality of subscribers and inform one or more of the plurality of subscribers of an information of the available properties. In one example, the plurality of subscribers may include one or more of the following: a real estate seller, a seller's agent, a real estate buyer, a buyer's agent, a lender, an escrow officer, a broker, a title officer, an insurance agent, a repairer, an appraiser, a property inspector, a stager, an attorney, a transaction coordinator, etc. One skilled in the art would understand that the list of subscribers as presented herein is not meant to be comprehensive, and that it is within the scope and spirit of the present disclosure to add other actors or subtract actors from this example list.

In one example, each of the plurality of subscribers may opt in or opt out of being informed of particular types of information. In one example, the opting in or opting out may be performed by each subscriber or may be set up by one of the subscribers or subscriber's agent, which may be modified by each of the subscribers by their own preference.

In one example, the communication chat line accommodates multiaccess communication. In one example, multiaccess communication allows private and group messaging among the plurality of subscribers. In one example, the private message incorporates encryption for enhanced security in the multiaccess communication. In one example, multiaccess communication incorporates digital image transport for sharing of transaction imagery (e.g., property inspection photos, repair work photos, transaction documentation, etc.). In one example, the digital image transport conveys Joint Photographic Experts Group (JPEG) formatted image files. In one example, the multiaccess communication includes acknowledgment requests and acknowledgment messages.

In one example, the information of the one or more available properties may be obtained through the use of virtual reality/augmented reality (VR/AR) technology. In one example, the information of the one or more available properties may include location of the property, quantity of bedrooms, quantity of bathrooms, single story building or multi-story building, pricing, age of the building, garage information, minimum or maximum lot size, yard size information, photos, virtual tour video, comparable sales data, sale history, listing history, affordability data (such as estimated monthly payment and estimated annual property tax amount), current loan interest rate, housing repair history, other statistics relating to each of the available property, etc.

In block 1840, establish a transaction timeline by incorporating a plurality of actions and an associated plurality of date/time alerts for a selected property from the available properties. In one example, the selected property is the property that a buyer has expressed an interest in purchasing and a seller has expressed an interest in selling.

In block 1850, disseminate one or more communications relating to the plurality of actions and the associated plurality of date/time alerts for the selected property using the communication chat line to the one or more of the plurality of subscribers. In one example, the one or more communications is a text or an email relating to one or more of the plurality of actions and/or one or more of the associated plurality of date/time alerts for the selected property.

In one example, the plurality of actions may include one or more of the following: preparing escrow documents, executing property appraisal, executing a property inspection, performing repairs, completing a loan application, depositing escrow money, filing title documents, initiating insurance coverage, etc. One skilled in the art would understand that the list of plurality of actions disclosed herein is not limiting and that other actions may be included or some of those listed may be excluded and still fall within the scope and spirit of the present disclosure.

In one example, one or more of the plurality of actions is associated to one or more date/time alerts which may include time reminders to complete the action and/or deadlines to complete the action. In one example, the date/time alert is cleared upon receipt of an acknowledgment with a timestamp from a responsible participant. In one example, the timestamp is obtained from a reference clock available to the machine-based communication tools. In one example, the reference clock is derived from a common source such as a wireless phone network or a satellite-based navigation system (e.g., GPS). In one example, the responsible participant need not be one of the plurality of subscribers.

In block 1860, track one or more of the plurality of actions based on the associated plurality of date/time alerts. In one example, the tracking uses timestamps to determine a trigger for sending one or more of the associated plurality of date/time alerts. In block 1870. send one or more of the associated plurality of date/time alerts to the plurality of subscribers using the communication chat line. In block 1880, inform the one or more of the plurality of subscribers of a status of the one or more of the plurality of actions using the communication chat line. In one example, the status is that an action has an upcoming deadline for completion or that an action has been completed. One skilled in the art would understand that other types of status of an action are within the scope and spirit of the present disclosure.

For example, an action is tracked using the machine-based communication tool to ensure that its associated date/time alerts are met. That is, if there's a deadline to complete an action, the machine-based communication tool sends one or more messages to remind the plurality of subscribers of the deadline associated with that action. And once there's an acknowledgement that the action has been completed, the machine-based communication tool may mark the action as completed without further reminders.

In block 1890, provide one or more documentation of the plurality of actions to the one or more of the plurality of subscribers using the communication chat line. In one example, the one or more documentation may be a text file, a PDF file, a WORD file, a PowerPoint file, etc. In one example, the one or more documentation is provided upon completion of the sale of the selected property.

In one example, the sales completion is defined as the close of escrow with all purchasing funds transferred to the seller and keys (i.e., access) of the selected property given to the buyer. In another example, sales completion is indicated upon notification of title transfer from the seller to the buyer after escrow closes. In one example, the machine-based communication tool includes a feature using a numeric rating of one or more subscriber of the plurality of subscribers. In one example, the numeric rating of each subscriber may be automatically shared on social media. In one example, the numeric rating may be displayed on a rating screen (e.g., display 1940) on the machine-based communication tool.

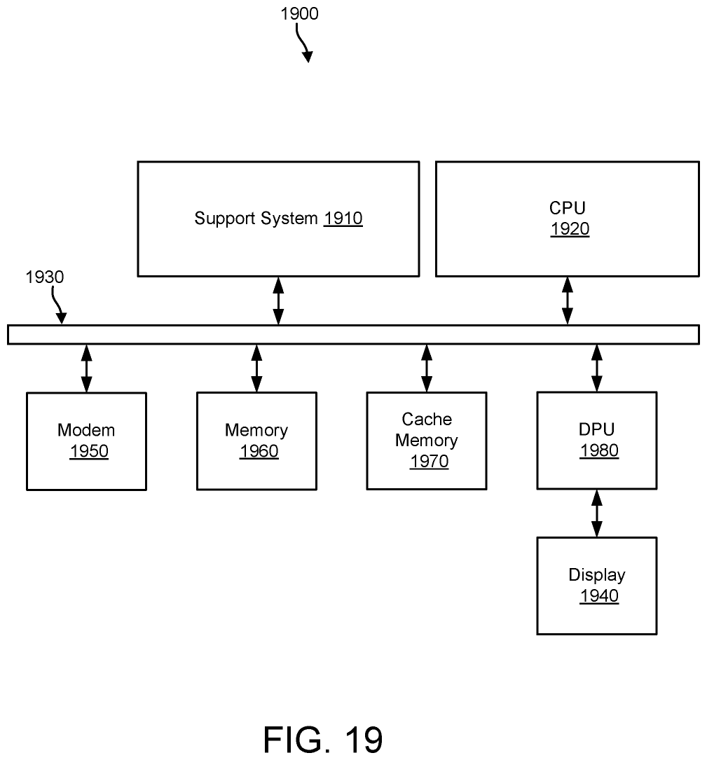

FIG. 19 illustrates an example implementation of a machine-based communication tool 1900. In one example, the machine-based communication tool 1900 includes a plurality of processing engines such as a central processing unit (CPU) 1920, a display processing unit (DPU) 1980, etc. In one example, various other functions in the machine-based communication tool 1900 may be included such as a support system 1910, a modem 1950, a memory 1960, a cache memory 1970 and a display 1940. For example, the plurality of processing engines and various other functions may be interconnected by an interconnection databus 1930 to transport data and control information. For example, the memory 1960 and/or the cache memory 1970 may be shared among the CPU 1920, display processing unit (DPU) 1980, and the other processing engines that may be added. In one example, the CPU 1920 may include a first internal memory which is not shared with the other processing engines. In one example, the DPU 1980 may include a second internal memory which is not shared with the other processing engines. In one example, any processing engine of the plurality of processing engines may have an internal memory which is not shared with the other processing engines.

In one example, the DPU 1980 controls the display 1940, e.g., by formatting data, buffering data, uncompressing data etc. In one example, the support system 1910 may include one or more of the following: an AC power supply, a battery pack, a speaker, a microphone, a camera, etc. In one example, the modem 1950 enables external communication using a wireless system. In one example, the memory 1960 serves as a primary repository of application software and data. In one example, the cache memory 1970 provides a faster repository for the plurality of processing engines. In one example, the display 1940 may 1940 may ingest static imagery (e.g., pictures) or dynamic imagery (e.g., video).

The following is an example illustration of an utility of the machine-based communication tool in accordance with the present disclosure. In one example, the machine-based communication tool in accordance with the present disclosure is a communications tool that brings multiple parties together for direct, up-to-the-minute status reports and conversations that are normally hindered by technical glitches, corporate firewalls and current software and communications limitations. For example, the machine-based communication tool is a simple, intuitive, and easy to use tool that provides all parties involved in a transaction with current, real-time status of all outstanding milestones, items, and issues.

In one example, the machine-based communication tool will break down the old way of doing business, promote transparency, increase productivity, improve the bottom line, allay worries, and will speed up the transaction process. For example, the machine-based communication tool is an industry specific artificial intelligence (AI) tool that creates a new way of visualizing and simplifying the old and complicated problem of keeping track of all the contacts, roles, sequential steps, assignments, communications, documents, and importantly, the current status of a collaborative transaction team workflow.

In one example, the Machine-based communication tool may be used for transaction-oriented industry but may excel in complicated multi-person workflows such as event planning and construction projects and law. In a real estate transaction, there are many team members who must collaborate to produce a successful transaction, such as agents, brokers, lenders, title attorneys, escrow officers, appraisers, banks, home inspectors, pest inspectors, home improvement contractors, engineers, stagers, painters, and so on. Everybody involved has their own role and their own job to do, receiving input and providing their work product to the team. But until now, all those team members worked in the dark with no “bird's eye view” of the overall transaction status and how their role fit into the overall process. For example, the buyer's and seller's agents may waste valuable time polling team members for status to discover and resolve bottlenecks in the process that could spell the difference between failure and a successful transaction.

Here's an example of how machine-based communication tool may work. In one example, the machine-based communication tool is an App, a software program for implementation on a processor and/or a software/hardware combination. In one example, the machine-based communication tool extends and augments the real estate agent transaction coordinator liaison role by providing a single point application that is an inexpensive, easy to learn, and easy to use tool accessed by all the team members to provide real time status. Machine-based communication tool continuously or periodically shows progress and missed milestones in real time for any transaction, or any point in each transaction, which needs immediate attention. In one example, a user may set a periodic duration for updates or may choose continuous updates. In one example, the machine-based communication tool may be designed from the ground up to help identify, prevent, and eliminate or quickly resolve issues such as escrow fraud, wire fraud, lender issues, buyer issues, repair issues, earnest money deposit (EMD) issues, contingency issues, and communications lag. This allows the agents to focus on client service and facilitating the transaction completion rather than wasting time collecting status reports, thus saving valuable time and overhead on administrative expenses. Buyers and Sellers get a bird's eye view of the importance of the real estate professionals in a transaction.

In one example, a subscribing real estate agent downloads the machine-based communication tool on a smartphone, a smart tablet (e.g., Ipad), a processor, or desktop personal computer (PC). When a new escrow opens, the machine-based communication tool subscriber adds all other parties to the transaction (clients, escrow agent, lender/loan processor, attorney, stagers, property inspectors, transaction coordinators, etc.) and the machine-based communication tool using artificial intelligences (AI) takes over from there.

In one example, action items may be flagged via a timeline (e.g., using the machine-based communication tool). In one example, the machine-based communication tool notifies the affected party or parties via an alert that there is an urgent task requiring their immediate attention in a task list. For example, the seller's agent may send a message (e.g., with or without Acknowledgement required) to the buyer's agent as follows: “Earnest Money Deposit is due today by 5:00 p.m.” Although directed to the buyer's agent, all parties in the transaction would be able to see it.

In one example, with the tap of a screen, each party may acknowledge receipt of each communication. In one example, the machine-based communication tool timestamps each party's acknowledgement of each action item. When escrow closes, all parties may download a file (e.g., a text file, a PDF file, a WORD file, a PowerPoint file, etc.) of the entire machine-based communication tool communication thread and add it to their transaction file as a complete record. Thus, in one example, no longer will clients have to ask their agents, “What's going on? Or “What happens next?”

In one example, following close of escrow, the machine-based communication tool may contact all parties to provide a rating of the professionals involved in that transaction. This feature adds an opportunity for users and companies to strive for machine-based communication tool's 5-Star Rating, which may be a popular marketing feature.

In one example, the lives of agents using the machine-based communication tool may be further enhanced a “Ringer” Feature. In one example, the Ringer is in effect a plug-in to the machine-based communication tool which would add further efficiencies to the real estate transaction process by integrating it with the information provided in the Multiple Listing Service (MLS) servers. For example, when a client describes to their agent the attributes of a home they are looking for and the general areas/locations in which they are most interested in looking, the agent may search the MLS information based on those criteria. When the agent finds one or more homes that meet the desired criteria, the agent may click on the Ringer icon which will move the homes data into the Ringer application. In one example, the Ringer may provide the clients with the description of the house and details on a map software with a direction route to get to the location. In one example, the suggested direction route is the most time or distance efficient way for the clients to get to that location.

In one example, when there is more than one potential property to view, the Ringer will plot the most efficient course to take on available maps software to get to each location in the least amount of time or in the shortest distance routes for each property. In one example the Ringer further streamlines the transaction process, frees up additional time for the agent for personal pursuits and allows the agent to focus on providing the best customer service to his or her clients, resulting in repeat business.

In one example, the machine-based communication tool may include a Bank App. For example, the Bank App feature may eliminate chances of wire fraud and may create an environment of safety and trust for all industries. In one aspect, the machine-based communication tool may be implemented in many different industries in addition to the banking industry, for example, residential real estate, legal, manufacturing, event planning, and residential and commercial construction projects, etc. In one example the machine-based communication tool may be positioned in any industry that requires the involvement of multiple participants in a single transaction, event, or project in order to bring about a successful result. For example, the machine-based communication tool may be used to solve the two largest problems professionals in these industries have been experiencing: communication and coordination of activities. In one example, the machine-based communication tool provides accountability in any work environment that relies on communication, coordination, timeliness, security, and confidentiality.

In one example, the machine-based communication tool may be used in the residential real estate sales industry. This industry is much broader than just buyer's and seller's agents. Throughout the country, lenders, loan processors, title companies, closing document coordinators, insurance companies, inspectors, and lawyers operating in the real estate world would benefit from subscribing to and using the machine-based communication tool. The time savings alone makes machine-based communication tool a worthwhile investment in their business.

For example, to maximize productivity, agents may need flexible, mobile-friendly tools that enable easy and effective team collaboration with streamlined workflows. If, for example, the agent mentioned above could open an app and immediately report to the client “where they're at” . . . that piece of technology would truly be a service of the agent.” In one example, the machine-based communication tool is that piece of technology.

Also, the machine-based communication tool includes additional features. For example, the client may not even have to make a call. His or her agent, using the features of the machine-based communication tool could set it up such that the client just needs to open the machine-based communication tool and receive the answer. In one aspect, the machine-based communication tool adds simplicity and efficiency to the management of business. For example, the machine-based communication tool may allow agents to handle more business more effortlessly, grow their name recognition and profitability by spending more time on business development and closings and less time on chasing transaction parties to get current information.

Example features of the machine-based communication tool are listed herein. In one example, the term “Circle” as used in this example, refers to an icon to access features of the machine-based communication tool. In one example, the “Circle” icon may appear on a user screen of a platform (e.g., a smartphone, a smart tablet, a processor, a desktop computer, etc.)

Badges/Notifications: If you select to allow or enable notifications in account settings, you will:
Get an alert whenever a new message(s) arrives that needs your attention; tap on message notifications to access all chat messages for that Circle.
Once per day, receive a reminder if you have overdue tasks on a Circle
Have an app badge icon that reflects your total number of outstanding messages and tasks. Note: this feature is available on iOS only. Welcome Back Screen: At the log in screen, you may select “stay logged in”; then whenever you return to the app, the Welcome Back Screen will give you the choice of selecting:
Go to Dashboard
OR
Tap address to go to active transaction(s)
Then pop-up gives options to:
   Go to Task Lists
   Go to Active Chats

### Dashboard Screen:

Top Search Bar: You can search participants names, Property Address, etc.
Top Scrolling Circles on Dashboard:
   My Circles:
      Active Circles: All active Circles allows you to gain access to all information needed with a tap. A Participants Button shows red when not all participants have logged into the Active Circle, with a tap you can send them a text or email reminding them to log in and start the process.
      Completed Circles: View a list with names, status, percent complete (which might not be 100%, even though complete)
      Canceled Circles: All Circles that were in escrow that did not close. A copy of a detailed transcript is available for download for your records with all of the pertinent information.
      Under Completed Circles:
         Ratings: View your aggregate star rating for this Circle if you have received ratings (professional participants only)
         Access the Ratings screen so that you can leave ratings for other professional participants.
Task List: This is a list of automatically generated escrow tasks broken down in 3 stages of your escrow (Opening, Discovery, and Closing) assigned to the correct professional and client. Choose another participant by highlighting their name to view their tasks and the percentage of their tasks that are complete.
   Open the task list associated with address: Choose no participant (i.e., deselect the current participant) to view all tasks for all participants and an overall percent complete. For a quick status, look at the stage box a red border means their tasks are late. When you click the Stage Box, it will reveal who the stage is waiting for and you have the option to send a reminder email to the individual or individuals that are late.
   Tap a task to mark it complete, or uncomplete it if it is already complete. You can see all tasks but can only complete tasks that are assigned to you.
   There will be a delay of approximately 5-10 seconds after tapping a task before the change takes effect; this is to give you time to undo it if you accidentally complete or uncomplete a task without really meaning to. Tapping the task again to toggle it back to its original state within this time frame will prevent a notification from being sent to other users about the change.
   When a task is completed (or reverted to incomplete), a message will go out to all participants. This message will require acknowledgment
   Task Details: Accessed by tapping the three dots next to a task on the Task List.
      If you are the Circle originator, then from this screen, you can change the task due date, add/remove task assignees, and/or cancel the task. All of these operations will generate messages.
Active Chats: Circles powerful central communication center. All communications for your deals are here and recorded via a transcript. Everything that requires an acknowledgement, Images shared, tasks completed or not, and all chat threads between the Circle or private messages are recorded in transcript.
Messages are displayed in blocks of 20, with messages requiring any acknowledgment always appearing first until acknowledged. This may mean that recent messages you have sent and/or received will not appear until you click acknowledged button* on all requiring acknowledgement, then the system will refresh, and you will be able to see the latest texts.
   * The sender will be notified of your acknowledgment.
Navigate up and down through the messages with the “Up 20” and “Oldest” buttons to go back in time and the “Down 20” and “Newest” buttons to go forward in time or hit the refresh button to go to the latest message.
You can search messages by content, as well as filtering for only messages that contain pictures. Once you are finished tap the search icon to go back to the latest message.
Messages will display within them a list of recipients, where applicable. If the message required acknowledgment, participants who have not yet acknowledged will appear in red with a small circular arrow symbol to their left.
You can send pictures with messages (one per message) using the camera icon to take a picture or choose an existing picture from the device's photo library.
   To remove a picture from a message, tap the grey “X” in the picture preview To view a larger picture in a chat message, tap on it; to close the large p picture, tap the grey “X” in the upper right-hand corner.
   To see only messages to/from a specific user, tap on the username in the list across the top, or tap on one of their attribution bubbles in the message list.
   You can also do this to choose user(s) to send them a semi-private message.
   Semi-private messages will still be included in the final transcript but will not be visible to other users while the Circle is active.
   There are restrictions on who can send and receive messages. For instance, sellers cannot send messages directly to buyers or their agents, and vice versa. If you have selected user(s) you cannot message directly, the screen will display this information and you will not be allowed to send a message while the user(s) are selected.
   Tap a user again to deselect them, or tap the grey X in the “selected users” list (at the bottom of the messaging screen) to deselect all users.
   Tap the refresh button to check for new messages.
Escrow Calendar: This is where your transaction/escrow specific schedule is made and can be viewed. This is NOT attached to your system's calendar, so you won't be able to see (Johnny's Birthday) here. You will only see specific date range and escrow business only or deal associated scheduling and will be able to plan your life around your business.
Account Settings: This is where you can customize notifications, fill in and change your information, including password.

### Buttons on Dashboard:

New Escrow/Circle It! You will be directed to a brief form that will walk you through starting a new Circle for a new escrow. Once completed hit the “Circle It!” button and your app will have all of the information sorted as per role and lists created via timelines set by the Close of Escrow date.
Contacts: This is an automated contact management and sharing system. You will be able to “Share to Circle” with any contact that you think will benefit your Circle with a tap of a check box. No more trying to locate the v-card, email, text etc. just tap the box, and all within specified Circle will have access to your native contacts to make it even easier. Utilities Companies and Vendors! Share to help easily and only share to the Circles you decide!
Transcripts: This will give you access to all your Completed and Active Circles transcripts detailing all information during the escrow process:
   Pertinent information of Professionals involved
   Active or Closed status of Circle
   All Parties Involved
   Escrow Information
TOC (Table of Contents):
   Cover sheet
   Table of Contents
   Acknowledged Messages
   Un-Acknowledged Messages
   Tasks
   Images
   Chat Tread
   Push Notifications Sent
   Email Notifications Sent
   Vendor Appointments
   Shared Contacts
Marketing: Another built-in automated feature of Circle that allows an Agent to market their success and ratings with automatically generated copy and paste marketing pieces to their preferred social media.
Circle Expert: Tap to access videos on how to use Circle and become an expert in minutes!
Contact Us: Tap to give us a shout!
Log Out: Tap to Log Out
   Bottom Ribbon: You can immediately go to with just a tap
Dashboard
Transcripts
Escrow Calendar
Plus-Button:
   From this powerful feature you can,
   Add or Change Role/Participant
   Add Task
   Change the Close of Escrow Date
   Delete A Circle
   View/Manage Contacts
   New Escrow/Circle It!
Contacts
Search:
   Search all Circles, Dates, Addresses, Names etc. for easy access.
Chat Screen
   Name Badges: At any time, you can long press others name badge in the Chat Screen, Task List, or Contacts to;
Initiate a phone call
Send a private message
Send email
Schedule an appointment on Escrow Calendar (in Contacts screen)

### Additional Examples:

An “Action Item” is a task that has calendar dependency, i.e., which must be finished by a particular date in order to proceed to next stage. Not all tasks are action items. If all your action items are complete for a date, that date will be highlighted in green. If you have overdue tasks for a date, that date will be highlighted in red.
Tasks can be added to the Escrow Calendar e.g., tenting, repairs, appraisal etc.
These added items will automatically transfer to the Chat screen for everyone's acknowledgement.
All pages except the Dashboard have a “Back” (top Left) button that will return you to the previous screen. I you keep tapping “Back” you will eventually get back to the Dashboard or just use bottom ribbon Dashboard icon.

Although many examples in the present disclosure may relate to real estate transactions, one skilled in the art would understand that other transactions that involves machine-based communication for transaction monitoring and/or execution are also within the spirit and scope of the present disclosure. Additionally, the disclosure of the attached Appendix A and Appendix B are incorporated by reference.

In one aspect, one or more of the steps for providing machine-based communication in FIG. 18 may be executed by one or more processors which may include hardware, software, firmware, etc. The one or more processors, for example, may be used to execute software or firmware needed to perform the steps in the flow diagram of FIG. 18. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. A method comprising:
enabling a communication chat line among a plurality of subscribers and informing one or more of the plurality of subscribers of an information of available properties;
establishing a transaction timeline by incorporating a plurality of actions and an associated plurality of date/time alerts for a selected property from the available properties; and
disseminating one or more communications relating to the plurality of actions and the associated plurality of date/time alerts for the selected property using the communication chat line to the one or more of the plurality of subscribers.

2. The method of claim 1, further comprising tracking one or more of the plurality of actions based on the associated plurality of date/time alerts.

3. The method of claim 2, further comprising sending one or more of the associated plurality of date/time alerts to the plurality of subscribers using the communication chat line.

4. The method of claim 3, further comprising informing the one or more of the plurality of subscribers of a status of the one or more of the plurality of actions using the communication chat line.

5. The method of claim 4, further comprising providing one or more documentation of the plurality of actions to the one or more of the plurality of subscribers using the communication chat line.

6. The method of claim 5, further comprising receiving a plurality of property criteria and using the plurality of property criteria to survey a database of available properties.

7. The method of claim 6, further comprising outputting a list of the available properties based on the plurality of property criteria.

8. The method of claim 7, further comprising gathering a numeric rating of one of the plurality of subscribers from another of the plurality of subscribers.

9. The method of claim 8, further comprising, upon completion of the gathering, posting the numeric rating on a social media platform.

10. The method of claim 1, wherein the communication chat line accommodates a multiaccess communication among the plurality of subscribers.

11. The method of claim 10, wherein the multiaccess communication includes a private group messaging using encryption.

12. An apparatus comprising:
a memory configured to store a database of available properties;
a central processing unit (CPU) coupled to the memory, the CPU configured to enable a communication chat line among a plurality of subscribers, and configured to establish a transaction timeline; and
a modem coupled to the CPU, the modem configured to disseminate one or more communications relating to a plurality of actions and an associated plurality of date/time alerts for a selected property; wherein the selected property is one of the available properties.

13. The apparatus of claim 12, wherein the CPU is further configured to incorporate the plurality of actions and the associated plurality of date/time alerts into the transaction timeline.

14. The apparatus of claim 13, further comprising a display coupled to the CPU, the display configured to inform at least one of the plurality of subscribers of a status of one of the plurality of actions.

15. The apparatus of claim 14, wherein the display is further configured to provide a documentation of the one of the plurality of actions to the at least one of the plurality of subscribers.

16. The apparatus of claim 12, wherein the modem is further configured to receive a plurality of property criteria.

17. The apparatus of claim 16, wherein the CPU is further configured to output a list of the available properties based on the plurality of property criteria.

18. The apparatus of claim 16, wherein the modem is further configured to allow multiaccess communication among the plurality of subscribers.

19. The apparatus of claim 12, wherein the CPU is further configured to gather a numeric rating of one of the plurality of subscribers from another of the plurality of subscribers, and further configured to post the numeric rating on a social media platform.

20. The apparatus of claim 14, further comprising a databus configured to allow coupling between any of the following: the memory, the CPU, the modem and the display.
